(19) United States
(12) Patent Application Publication
(10) Pub. No.: US 2016/0356245 A1
(43) Pub. Date: Dec. 8, 2016

(54) ROCKET MOTOR PRODUCED BY ADDITIVE MANUFACTURING

(71) Applicant: Raytheon Company, Waltham, MA (US)

(72) Inventors: Jeremy C. Danforth, Tucson, AZ (US); Teresa Perdue, Tucson, AZ (US); Mark T. Langhenry, Tucson, AZ (US); Matt H. Summers, Marana, AZ (US)

(21) Appl. No.: 14/729,390

(22) Filed: Jun. 3, 2015

(51) Int. Cl. F02K 9/95

(52) U.S. Cl. CPC F02K 9/95

(57) ABSTRACT

A nozzleless hybrid rocket motor includes a fuel element that defines a combustion chamber therewithin, in which combustion of the fuel and an oxidizer occurs. The combustion gases produced by the combustion between the fuel and the oxidizer transition to supersonic flow before leaving the fuel element, eliminating the need for a separate nozzle. The fuel element may be a part of a structural element of a vehicle, for example being a part of a fuselage, wing, fairing, or other part of a space vehicle or an air vehicle, with the fuel element an integral and continuous part of the structural element. Combustion of part of the fuel element may allow vehicle structure to be used to provide thrust, such as for maneuver, consuming part of the structure. The fuel element may be made by an additive manufacturing process.

### FIELD OF THE INVENTION

The invention is in the field of rocket motors.

### DESCRIPTION OF THE RELATED ART

Additive-manufactured fuel grains have been produced before, albeit for rocket motors using conventional metal casings and nozzles.

### SUMMARY OF THE INVENTION

A nozzleless rocket motor has cavities within an additive-manufactured fuel element that are used to hold oxidizer, and function as a combustion cavity for burning the fuel, and producing thrust by expelling the combustion products. The fuel element may be part of a larger element of an air vehicle or space vehicle, such as a fuselage or element extending from a fuselage (wing, canard, fin, rudder, elevator, etc.). The fuel elements may be made of the same material as the larger element, and may be produced using the same method, with multiple rocket motors being integrally imbedded in larger elements, for example to enhance maneuverability.

According to an aspect of the invention, a flying vehicle includes: a hybrid rocket motor including: a caseless fuel element having one or more chambers therein; an oxidizer; and an igniter; wherein the one or more chambers include a combustion chamber in which combustion of fuel of the fuel element and the oxidizer occurs, when ignited by the igniter.

According to an embodiment of the device of any prior paragraph, the fuel element is made in an additive manufacturing process that defines the one or more chambers as fuel material is added to the fuel element.

According to an embodiment of the device of any prior paragraph, the one or more chambers include an oxidizer storage chamber that holds the oxidizer prior to combustion.

According to an embodiment of the device of any prior paragraph, the igniter is connected to the combustion chamber by a feed line that is an opening within the fuel element that is defined by the fuel element.

According to an embodiment of the device of any prior paragraph, the igniter is secured by the fuel element, with the igniter in a cavity in the fuel element.

According to an embodiment of the device of any prior paragraph, the hybrid rocket motor is a nozzleless motor, with the combustion producing a supersonic flow in the combustion chamber.

According to an embodiment of the device of any prior paragraph, the fuel element is a part of a larger element of the flying vehicle.

According to an embodiment of the device of any prior paragraph, the fuel of the fuel element is continuous with, integrally formed with, and of the same material as, other portions of the larger element.

According to an embodiment of the device of any prior paragraph, the other portions include additional chambers that are part of one or more additional rocket motors, with the material of the other portions constituting fuel for the one or more additional rocket motors.

According to an embodiment of the device of any prior paragraph, the rocket motor provides a different amount of thrust and/or thrust in a different direction than the one or more additional rocket motors.

According to an embodiment of the device of any prior paragraph, the larger element is a structural element.

According to an embodiment of the device of any prior paragraph, the combustion of the fuel element structurally weakens the structural element.

According to an embodiment of the device of any prior paragraph, the other parts of the larger element are not consumed by the combustion.

According to an embodiment of the device of any prior paragraph, the vehicle is an air vehicle.

According to an embodiment of the device of any prior paragraph, the vehicle is a flying vehicle.

According to another aspect of the invention, a method of operating a flying vehicle includes the steps of: operating the vehicle during a first time period, in which the vehicle encounters relatively high structural stresses; operating the vehicles during a second time period, after the first time period, in which the vehicle encounters relatively lower structural stresses; and after the first time period, burning part of a structure of the vehicle as fuel, thereby reducing structural integrity of the vehicle.

According to an embodiment of the device of any prior paragraph, the flying vehicle is a space vehicle.

According to an embodiment of the device of any prior paragraph, the first time period includes launching of the space vehicle.

According to an embodiment of the device of any prior paragraph, the flying vehicle is an air vehicle.

According to an embodiment of the device of any prior paragraph, the second time period includes maneuvering the vehicles by burning part of the structure.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

The annexed drawings, which are not necessarily to scale, show various aspects of the invention.

FIG. 1 is a side sectional view of a rocket motor in accordance with an embodiment of the present invention.

FIG. 2 is a side sectional view of a portion of the rocket motor of FIG. 1, at a first time after combustion has commenced.

FIG. 3 is a side sectional view of a portion of the rocket motor of FIG. 1, at a second (later) time after combustion has commenced.

FIG. 4 shows a side view of a combustion chamber of a rocket motor in accordance with another embodiment of the invention.

FIG. 5 is a side view of a space vehicle that includes multiple of the rocket motors, as in FIG. 1.

FIG. 6 is a side sectional view of a portion of a flying vehicle, with a pair of rocket motors integrated therein.

FIG. 7 is an oblique view of an air vehicle that includes multiple rocket motors integrated therein.

### DETAILED DESCRIPTION

A nozzleless hybrid rocket motor includes a fuel element that defines a combustion chamber therewithin, in which combustion of the fuel and an oxidizer occurs. The combustion gases produced by the combustion between the fuel and the oxidizer transition to supersonic flow before leaving the fuel element, eliminating the need for a separate nozzle. The fuel element may be a part of a structural element of a vehicle, for example being a part of a fuselage, wing, fairing, or other part of a space vehicle or an air vehicle, with the fuel element an integral and continuous part of the structural element. Combustion of part of the fuel element may allow vehicle structure to be used to provide thrust, such as for maneuvering, consuming part of the structure. The fuel element may be made by an additive process, for example forming the chambers therein by building up the fuel element layer by layer.

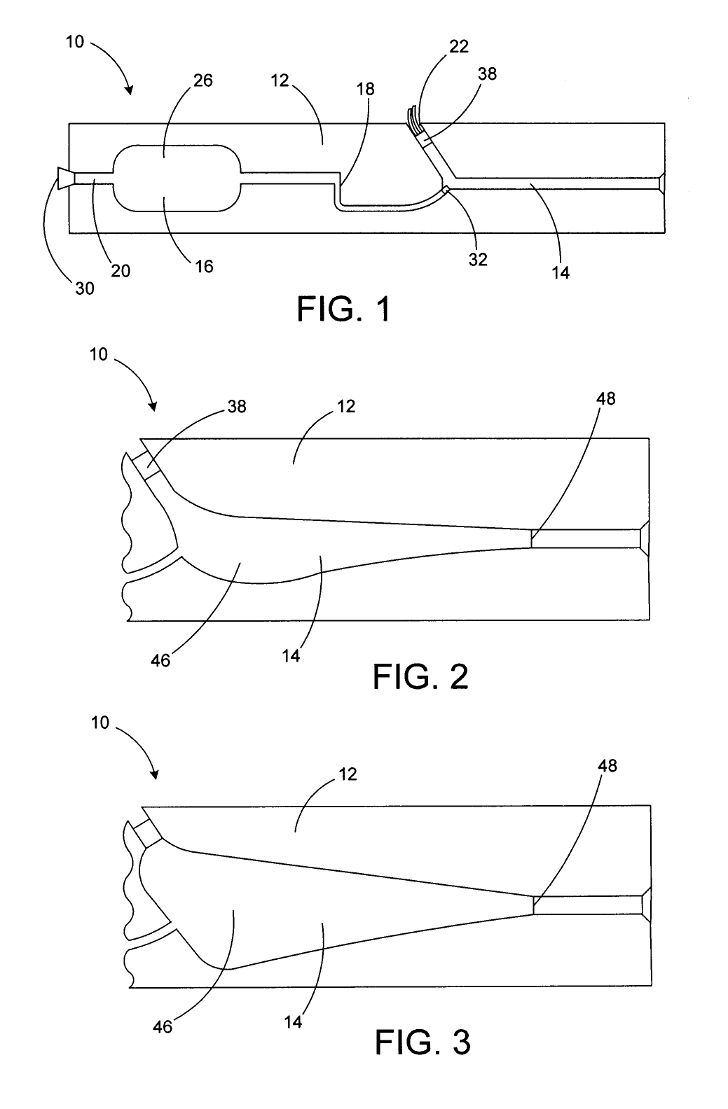

FIG. 1 shows a nozzleless hybrid rocket motor 10 which has a fuel element 12 that forms the structure for the motor 10, and does not require any sort of casing or other containment. The fuel element has a number of chambers or passages therein, including a combustion chamber 14, an oxidizer storage chamber 16, an oxidizer feed line 18, an oxidizer fill port 20, and an igniter port 22. An oxidizer 26 is stored in the oxidizer chamber 16, having been filled through the fill port 20. After filling, the fill passage may be blocked with a fill plug 30. A feed plug 32 is placed in the feed line 18, to prevent oxidizer from prematurely entering the combustion chamber 14. The feed plug 32 may be made of a suitable plastic.

An igniter 38 is located in the igniter port 22. The igniter 38, which may be electrically actuated, provides sufficient energy to dislodge the feed plug 32, which allows oxidizer to flow into the combustion chamber 14. The igniter 38 also provides energy to initiate a combustion reaction in the combustion chamber 14, with the igniter 38 heating some of the nearby fuel sufficiently to initiate a combustion reaction. The igniter 38 may be any of a variety of suitable types of igniters, for example including an energetic combustible mixture combustion, or an igniter that can be initiated by electrical heating.

The combustion chamber 14 may be shaped so as to facilitate combustion, so as to be able to allow the flow coming out of the rocket motor 10 to transition to supersonic flow before exiting the combustion chamber 14, and without need for a separate nozzle. The combustion chamber 14 may be initially a cylindrical chamber of sufficient length so as to cause the flow to transition to supersonic flow within the cylindrical chamber. The combustion chamber 14 may initially have any of a wide variety of other initial shapes, for example other shapes that do not have a traditional throat, or converge-diverge shape associated with nozzles. In addition, the shape of the combustion chamber 14 may change over time, as material along the boundaries of the combustion chamber 14 is burned. This burning of material will increase the diameter of the combustion chamber 14, and in doing so will generally not increase the diameter uniformly at all axial locations along the length of the combustion chamber 14.

For example, the combustion chamber 14 may start as cylindrical, as shown in FIG. 1. Burning of the fuel 12 around the outside of the combustion chamber 14 may produce a situation like that shown in FIG. 2, where the combustion chamber 14 has been transformed in to a long circular cone. More of the fuel has been burned off at an upstream end 46 of the combustion chamber 14, near the feed line 18 and the igniter 38. This uneven burning makes the combustion chamber 14 wider at its upstream end 46, narrowing downstream to a choke point 48, where the combustion chamber 14 has a minimum diameter. The choke point 48 may continue to move downstream away from the end 46 as the burning continues, for example as shown in FIG. 3.

The fuel element 12 may act as a self-supporting member, in that it supports the hybrid rocket motor 10, which does not require any sort of separate containment element, such as a case. Prior fuel elements have often required a separate casing for pressure containment, which may be dispensed with in the motor 12. The ability of the fuel element 12 to be self-supporting, without a need for a casing, may be related to a small size of the fuel element 12. For example, the fuel element 12 may have a size, such as a diameter, that it is such that the fuel element 12 supports itself before and during burning. The fuel element 12 and the burning may be such that the fuel element 12 continues to maintain self-supporting integrity even after the burning has been completed. For example, the load-carrying thickness of the fuel element 12 (or a part of the fuel element 12) may be greater than the internal pressure times the diameter, divided by twice the tensile strength of the material. This provides a measure of sufficient resistance against hoop stresses caused by the internal pressure of the burning fuel.

In addition, the fuel element 12 may be part of a structural member, such as a wing, fuselage, or fairing of a vehicle, such as an air vehicle or space vehicle. In being part of the larger structure, the fuel element 12 may be made of the same material as a structure element or member that it is part of. Therefore, the part of the structure element that actually burns as fuel may be just a small part of a larger member that provides structural support to the rocket motor 10, or to the vehicle more generally. The structural function may be performed by the structural member before the burning of all or part of the fuel, and also may be performed after some of the fuel is burned.

The burning of part or all of the fuel element 12 may weaken the structural integrity of the structural member that the rocket motor 10 is a part of. Thus the vehicle that the rocket motor 10 is a part of may be configured to fire the rocket motor 10 only after the structure has withstood its greatest loads (which may be part of a process that involves firing of another rocket motor, perhaps a main thruster).

Alternatively, the fuel element 12 may be in a part that is not a structural member. As another alternative, the fuel element 12 may include a nozzle, either a separately-produced piece, or a cavity or portion of the combustion chamber 14 that changes in area to provide a converging portion and a diverging portions that aids in having the flow of combustion products transition to supersonic flow.

The term “structural member,” as used herein, refers to a member that provides support to other parts of a larger structure, by passing (transferring) a load therethrough. This passing of a load therethrough may be referred to herein as a “structural function.” Structural members may be internal load-bearing supports of a structure, for providing integrity to the structure such that the structure would be significantly weakened if the structural members were removed. In addition, structural members may aid in allowing the structure or a part of the structure to resist external loads, such as aerodynamic loads on a fuselage, wing, or control surface. Excluded from the definition of “structural member” are parts that do not support, in the sense of transferring therethrough, loads from outside themselves.

The amount of burning of the fuel element 12 may be limited by controlling the amount of the oxidizer 26 that is available. This may be done to maintain a desired structural integrity, even after the burning has been accomplished. It will be appreciated that alternatively or in addition, in some circumstances the amount of burning may be limited in order to limit the amount of total thrust put out by the rocket motor 10.

The material for the fuel element 12 may be any of a wide variety of burnable materials. Non-limiting examples include rubber, dense plastics, and metals or metal compounds, such as magnesium or copper oxide. The fuel material may include suitable additives for better performance. Additives may be used to increase fuel density (allows more mass to be packaged per unit volume), to increase burning rate during combustion (a higher burn rate means a higher mass flow, which means increased thrust), and/or to increase flame temperature (improves combustion efficiency and specific impulse which is thrust per unit mass of propellant). Metal hydrides could be added to the printed fuel to increase energy content. Alternatively or in addition, ammonium perchlorate could be added to the printed plastic fuel to increase oxygen content. The oxidizer 26 may be any of a variety of suitable liquid oxidizer materials, for example oxygen or nitrous oxide.

The fuel element 12 may be made using an additive manufacturing process, such as a process in which the fuel element 12 is built up layer by layer. “Additive manufacturing” is broadly used herein to refer to processes in which features are formed by selectively adding material, as opposed to removing material from an already-existing larger structure (subtractive manufacturing). Such a process is often referred to generally as three-dimensional printing. The additive manufacturing process allows internal passages in the fuel element 12, such as the combustion chamber 14, the oxidizer storage chamber 16, the oxidizer feed line 18, the oxidizer fill port 20, and the igniter port 22, to be formed without additional manufacturing steps, such as machining. The fuel element 12 may be built up layer-by-layer in the direction parallel to the combustion chamber 14. Many types of additive manufacturing processes may be used to produce the fuel element 12. One example of a suitable process is fused deposition, where material is deposited at selected locations to build up the fuel element 12 layer by layer, with the deposited material fusing to previous layers of material. The fused deposition may involve movement of an extruder with a heated head, to deposit extruded material in desired locations. A variety of other additive manufacturing processes, such as selective laser sintering (SLS), stereo lithography (SLA), are possible as alternatives.

Other parts, such as the feed plug 32, may be embedded within the fuel element 12 as the fuel element 12 is built from the additive manufacturing process. Such other parts may be held in a desired location during the manufacturing process, with supports for the other parts being removed after the manufacturing process has progressed sufficiently for the under-construction fuel element 12 to hold the other parts in place.

The additive manufacturing process may advantageously allow the rocket motor 10 to be integrated into any of a variety of structures, having any of a variety of shapes. For example, small rocket motors may be integrated into a fuselage or wing of an aircraft, as described further below. Such small rocket motors may provide additional bursts of thrust, for example to enhance maneuverability of the aircraft.

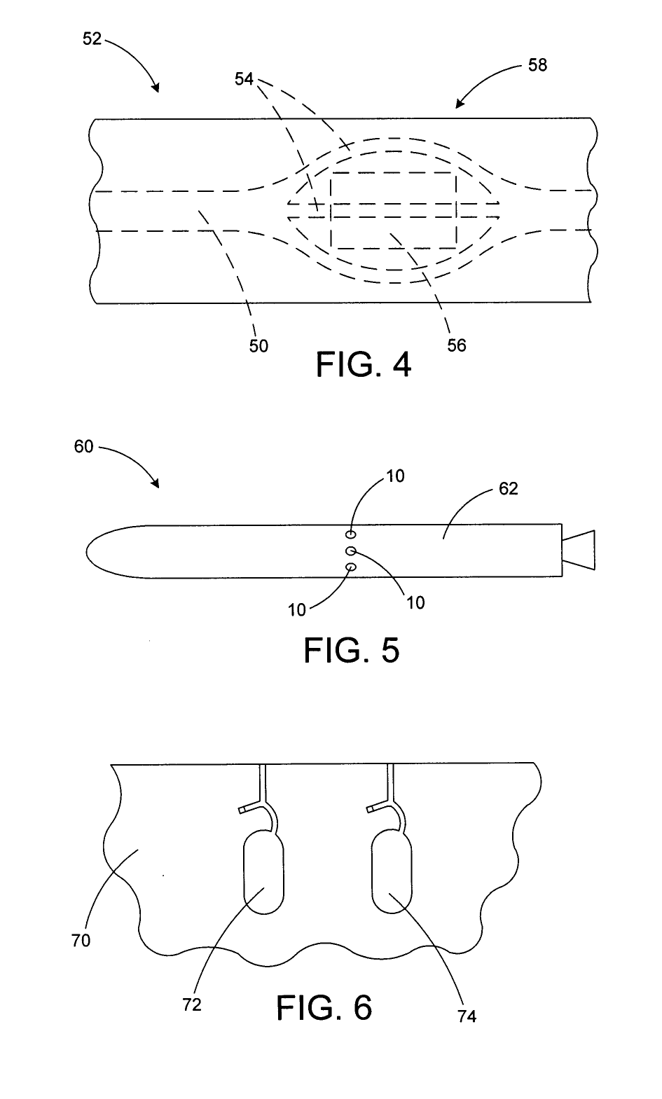

Many variations are possible for the rocket motor 10 shown in FIG. 1. For example, the sizes, shapes, and/or relative position of the various elements may vary from that shown in the illustrated embodiment. To give one example, with reference to FIG. 4, a combustion chamber 50 for a rocket motor 52 may be configured to split into multiple separate downstream passages, such as three or four separate passages 54, to pass around another air or space vehicle system, such as a control actuation system 56 in the aft part of a missile 58. Such a configuration may be an alternative to traditional motor structures such as blast tubes, which add mass and failure modes, such as failure at joint between the blast tube and other parts of the system. In a motor such as that of the present invention, joints are avoided, which reduces failure modes.

FIG. 5 shows the rocket motor 10 as part of a fuselage 62 of a space vehicle 60. The rocket motor 10 may be one of a series of rocket motors, all shown in FIG. 2 as reference number 10, at various locations in the fuselage 62, to provide thrust for maneuver or for other propulsion of the space vehicle 60. The rocket motors 10 may be oriented to provide thrust in different directions, to provide different sorts of thrust, for example to change roll, pitch, and/or yaw. The various rocket motors also may be configured to translate the space vehicle 60, for example to translate the space vehicle 60 by small amounts to maintain it on a desired course, for example as it approaches a target or other intended destination.

The rocket motors 10 may all provide substantially the same amount of thrust. Alternatively different of the rocket motors 10 may provide different amounts of thrust. A control system (not shown) may be configured to selectively activate one or more of the rocket motors 10 to provide the desired thrust (in magnitude and/or direction).

Firing of the rocket motors 10 may weaken the fuselage 62 of the space vehicle 60. However the space vehicle 60 may be configured to confine rocket firing to times after which the space vehicle 60 has already encountered its maximum structural stresses or loads. For example the space vehicle 60 may encounter maximum stresses during launch, with the rocket motors 10 only fired after the launch phase has passed.

The fuel for the various rocket motors 10 may be the same material as that of the rest of the fuselage 62. The fuel elements may be parts of a continuous, unitary single piece of material that forms the fuselage of the space vehicle 50, with multiple cavities within the same piece of material (such as for receiving oxidizer, and allowing combustion) may form parts of different of the rocket motors 10. FIG. 6 shows such a single, unitary, continuous part 70 that provides cavities 72 and 74 for and fuel elements for a pair of separate of the rocket motors 10. All of the rocket motors 10 may be in the same part, or groups or individual of the rocket motors 10 may be in separate parts.

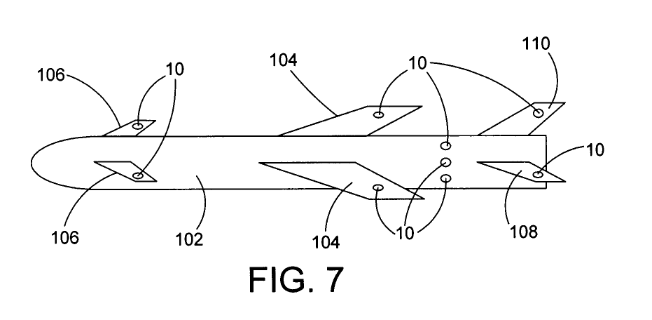

One or more rocket motors 10 may be part of the fuselage of other types of vehicles, such as part of an air vehicle to be used within an atmosphere. Alternatively, or in addition, one or more rocket motors 10 may be located in other parts of air vehicles, such as is illustrated using the air vehicle 100 shown in FIG. 7. The air vehicle 100 has rocket motors 10 located in a fuselage 102, wings 104, canards 106, elevators 108, and a rudder 110. The rocket motors 10 may be located in skins of such parts. The rockets motors 10 may be located in all of these parts, or any combination of one or more of them. The rocket motors 10 may be located in fixed portions and/or movable portions of the various parts of the air vehicle 100. The rocket motors 10 may be configured to provide thrust, such as to enhance steering, in one or more suitable directions. Different of the rocket motors 10, even in the same part of the air vehicle 100, may be oriented to provide desired roll, pitch, and/or yaw moments. Different of the rocket motors 10 may be configured to provide different amounts of thrust, either the specific thrust at any given time, and/or the total thrust for fully firing the rocket motors 10.

The rocket motors 10 may be located at positions in the space vehicle 50 (FIG. 4) or the air vehicle 100 (FIG. 5) where the firing of the rocket motors 10 will not unduly weaken the parts they are in. For example, a main rocket motor may be located in an aft section of a missile, where fins and a fin actuation system of the missile are located.

As with the space vehicle 50 (FIG. 4), multiple of the rocket motors 10 of the air vehicle 100 (FIG. 6) may be in single, unitary, continuous piece of material, in a manner similar to the piece of material 70 (FIG. 5). A single piece with multiple of the rocket motors 10 may be all or a portion of a single of the parts of the air vehicle 100 (the fuselage 102, the wings 104, the canards 106, the elevators 108, and the rudder 110), or extend across multiple of the parts.

The illustrated air vehicle 100 is an unmanned aerial vehicle (UAV) or drone. However other sorts of air vehicles, such as manned air vehicles or missiles, might include rocket motors 10 in one or more of their various parts. In addition, one or more rocket motors 10 may also be formed in other types of flying vehicles, such as trans-atmospheric vehicles, which for example may be launched from the atmosphere, and transition to space flight.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A flying vehicle comprising:
a hybrid rocket motor including:
a caseless fuel element having one or more chambers therein;
an oxidizer; and
an igniter;
wherein the one or more chambers include a combustion chamber in which combustion of fuel of the fuel element and the oxidizer occurs, when ignited by the igniter.

2. The flying vehicle of claim 1, wherein the fuel element is made in an additive manufacturing process that defines the one or more chambers as fuel material is added to the fuel element.

3. The flying vehicle of claim 1, wherein the one or more chambers include an oxidizer storage chamber that holds the oxidizer prior to combustion.

4. The flying vehicle of claim 3, wherein the igniter is connected to the combustion chamber by a feed line that is an opening within the fuel element that is defined by the fuel element.

5. The flying vehicle of claim 1, wherein the igniter is secured by the fuel element, with the igniter in a cavity in the fuel element.

6. The flying vehicle of claim 1, wherein the hybrid rocket motor is a nozzleless motor, with the combustion producing a supersonic flow in the combustion chamber.

7. The flying vehicle of claim 1, wherein the fuel element is a part of a larger element of the flying vehicle.

8. The flying vehicle of claim 7, wherein the fuel of the fuel element is continuous with, integrally formed with, and of the same material as, other portions of the larger element.

9. The flying vehicle of claim 8, wherein the other portions include additional chambers that are part of one or more additional rocket motors, with the material of the other portions constituting fuel for the one or more additional rocket motors.

10. The flying vehicle of claim 9, wherein the rocket motor provides a different amount of thrust and/or thrust in a different direction than the one or more additional rocket motors.

11. The flying vehicle of claim 7, wherein the larger element is a structural element.

12. The flying vehicle of claim 11, wherein the combustion of the fuel element structurally weakens the structural element.

13. The flying vehicle of claim 11, wherein the other parts of the larger element are not consumed by the combustion.

14. The flying vehicle of claim 1, wherein the vehicle is an air vehicle.

15. The flying vehicle of claim 1, wherein the vehicle is a flying vehicle.

16. A method of operating a flying vehicle, the method comprising:
operating the vehicle during a first time period, in which the vehicle encounters relatively high structural stresses;
operating the vehicles during a second time period, after the first time period, in which the vehicle encounters relatively lower structural stresses; and
after the first time period, burning part of a structure of the vehicle as fuel, thereby reducing structural integrity of the vehicle.

17. The method of claim 16, wherein the flying vehicle is a space vehicle.

18. The method of claim 17, wherein the first time period includes launching of the space vehicle.

19. The method of claim 16, wherein the flying vehicle is an air vehicle.

20. The method of claim 16, wherein the second time period includes maneuvering the vehicles by burning part of the structure.
